(19) United States
(12) Patent Application Publication
(10) Pub. No.: US 2007/0031753 A1
(43) Pub. Date: Feb. 8, 2007

(54) Polyurethane member for use in electrophotographic apparatus

(75) Inventors: Shuji Abe, Yokohama-shi (JP); Miyuki Ueno, Yokohama-shi (JP); Shuhei Noda, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: HOKUSHIN CORPORATION

(21) Appl. No.: 11/498,056

(22) Filed: Aug. 3, 2006

(30) Foreign Application Priority Data
Aug. 5, 2005 (JP) 2005-228931

(51) Int. Cl. C08G 18/00; G03G 21/00

(52) U.S. Cl. 430/125; 528/44

(57) ABSTRACT

The invention provides an electrophotography polyurethane member which exhibits small temperature dependency of characteristics, excellent mechanical characteristics, and high wear resistance. The cast-type electrophotography polyurethane member produced through hardening and molding a polyurethane composition containing at least polyol, polyisocyanate, and a diamino compound, wherein the diamino compound has a melting point of 80° C. or lower and contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

The entire disclosure of Japanese Patent Application No. 2005-228931 filed Aug. 5, 2005 is expressly incorporated by reference herein.

### BACKGROUND OF THE INVENTION

1. Field of the Invention

The present invention relates to a polyurethane member for use in an electrophotographic apparatus (hereinafter referred to as an electrophotography polyurethane member) as a part such as a cleaning part, a development part, a charge-imparting part, an image-transfer part, or a paper-feed part. More particularly, the invention relates to an electrophotography polyurethane member preferably employed as a cleaning blade member for removing toner from a toner-image carrier (e.g., a photoreceptor or an image-transfer belt) which is provided with a toner image and subsequently transfers the toner image to an image-transfer member; a development member for use in a development part; a charge-imparting member which imparts electric charge to a photoreceptor; or a similar member.

2. Background Art

In a typical electrophotographic process, an electrophotographic photoreceptor undergoes at least the steps of charging, light-exposure, development, image-transfer, and cleaning. In such an electrophotographic process, polyurethane is employed as a member such as a cleaning member for removing toner from a toner-image carrier which is provided with a toner image and subsequently transfers the toner image to an image-transfer member; a development member for use in a development part; a charge-imparting member which imparts electric charge to a photoreceptor; or a similar member. The reason for use of polyurethane is that polyurethane exhibits excellent wear resistance and sufficient mechanical strength even without addition of an additive such as a reinforcing agent. Moreover, polyurethane is a material which does not stain an object to be processed. However, polyurethane is known to have temperature dependent physical properties. Among them, rebound resilience is particularly temperature-dependent, and the dependency poses a problem during a cleaning step carried out by use of a cleaning blade formed of polyurethane.

Japanese Patent Application Laid-Open (kokai) No. 2001-265190 discloses a polyurethane cleaning blade which exhibits a tensile strength (50° C.) of 12 MPa or higher, a tan δ peak temperature of 15° C. or lower, and a hardness of 80° or lower and which attains excellent cleaning performance over a wide temperature range. Specifically, cleaning performance is not impaired under low-temperature conditions, and chipping of an edge of the cleaning blade is effectively prevented under high-temperature conditions. As disclosed in the above patent document, temperature dependency of blade characteristics have conventionally been mitigated merely through controlling the tan δ peak temperature and intensity of the blade. However, even when the tan δ peak temperature and intensity are controlled, in some cases, wear resistance is impaired under high-temperature and high-humidity conditions (HH conditions).

Japanese Patent No. 3,666,331 discloses that a cleaning blade is produced by hardening a polyurethane composition containing polyisocyanate, polyol, and a diamino compound (2,2′,3,3′-tetrachloro-4,4′-diaminodiphenylmethane), in order to enhance wear resistance and chipping resistance at high temperature. However, since the diamino compound (2,2′,3,3′-tetrachloro-4,4′-diaminodiphenylmethane) employed for producing a cleaning blade exhibits high reaction rate, sheet formability of the polyurethane composition is unsatisfactory.

Therefore, there is demand for a cleaning blade which exhibits small temperature dependency of characteristics, excellent mechanical characteristics, and satisfactory wear resistance at high temperature.

### SUMMARY OF THE INVENTION

In view of the foregoing, an object of the present invention is to provide an electrophotography polyurethane member which exhibits small temperature dependency of characteristics, excellent mechanical characteristics, and high wear resistance.

A first mode of the present invention for attaining the mentioned object provides a cast-formable electrophotography polyurethane member produced through hardening and molding a polyurethane composition containing at least polyol, polyisocyanate, and a diamino compound, wherein the diamino compound has a melting point of 80° C. or lower and contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

A second mode of the present invention is drawn to a specific embodiment of the first mode, wherein the polyurethane member exhibits a tans peak intensity of 0.7 or lower and a (tan δ peak intensity/tans intensity at 50° C.) of 10 or less.

A third mode of the present invention is drawn to a specific embodiment of the first or second mode, wherein the diamino compound is incorporated into the polyurethane composition in an amount of 0.15 mmol/g or less.

A fourth mode of the present invention is drawn to a specific embodiment of any of the first to third modes, wherein the polyurethane member exhibits a tan δ (10 Hz) peak temperature of 5° C. or lower.

A fifth mode of the present invention is drawn to a specific embodiment of any of the first to fourth modes, wherein the polyurethane member exhibits a ((rebound resilience at 50° C.)−(rebound resilience at 10° C.)) of 40% or less.

A sixth mode of the present invention is drawn to a specific embodiment of any of the first to fifth modes, wherein the polyurethane member exhibits a hardness (JIS A) of 70 to 95°.

A seventh mode of the present invention is drawn to a specific embodiment of any of the first to sixth modes, wherein the polyurethane member is employed as a blade member.

### BRIEF DESCRIPTION OF THE DRAWING

FIG. 1 is a graph showing a tans intensity-temperature profile of the test samples of the Examples and Comparative Examples.

### DETAILED DESCRIPTION OF PREFERRED EMBODIMENTS

The present invention provides an electrophotography polyurethane member which exhibits small temperature dependency of characteristics, excellent mechanical characteristics, and high wear resistance. In one specific embodiment of the present invention, the electrophotography polyurethane member is formed of a polyurethane member produced through hardening and molding a polyurethane composition containing at least polyol, polyisocyanate, and a diamino compound, which has a melting point of 80° C. or lower and contains no chlorine atom but contains an aromatic ring in the molecular structure thereof and which exhibits a reaction rate slower than that of 2,2′,3,3′-tetrachloro-4,4′-diaminodiphenylmethane under given hardening and molding conditions.

When the diamino compound employed in the present invention contains no chlorine atom thereof, the compound has substantially no steric hindrance. Polyurethane hardened with the diamino compound which contains no chlorine atom but contains an aromatic ring in the molecular structure exhibits excellent mechanical strength.

By use of such a diamino compound which has a melting point of 80° C. or lower and contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions, the electrophotography polyurethane member of the present invention exhibits small temperature dependency of characteristics and excellent cleaning performance (mechanical strength and wear resistance). The diamino compound employed in the present invention may exhibit a reaction rate slower than that of 2,2′,3,3′-tetrachloro-4,4′-diaminodiphenylmethane. Thus, by use of such a diamino compound, failure of sheet formation due to excessively fast reaction rate can be prevented.

Conventionally, tan δ peak intensity has been employed as a parameter relating to temperature dependency of characteristics. However, the tans peak intensity has been confirmed to serve as a wear-resistance-related parameter. Accordingly, the electrophotography polyurethane member of the present invention is formed from a polyurethane member such that the tans peak intensity is regulated to 0.7 or less in order to mitigate temperature dependency and improve wear resistance.

The polyurethane member according to the present invention preferably exhibits a tan δ peak intensity of 0.7 or lower and a (tan δ peak intensity/tan δ intensity at 50° C.) of 10 or less. When the tans peak intensity is 0.7 or lower, the molecular structure becomes rigid, thereby enhancing wear resistance. When the (tans peak intensity/tan δ intensity at 50° C.) is 10 or less, a cleaning blade formed of the polyurethane member of the present invention exhibits excellent wear resistance and cleaning performance within a temperature range where the blade is employed. When the polyurethane member of the present invention exhibits a tans peak intensity of 0.7 or lower and a (tan δ peak intensity/tan δ intensity at 50° C.) of 10 or less, wear resistance and cleaning performance are more effectively enhanced, without being affected by change in temperature. The tan δ peak intensity and (tans peak intensity/tans intensity at 50° C.) of the polyurethane member of the present invention can be regulated to 0.7 or lower and 10 or less, respectively, through appropriately modifying the compositional proportions of polyol, polyisocyanate, and a diamino compound.

The polyurethane member preferably exhibits a tan δ (10 Hz) peak temperature of 5° C. or lower. When the tan δ (10 Hz) peak temperature is higher than 5° C., the polyurethane member loses rubber characteristics under low-temperature low-humidity conditions, readily resulting in chipping.

The polyurethane member of the present invention preferably exhibits a hardness, as stipulated by JIS A, of 70 to 95°. When the hardness falls within the range, sufficient cleaning performance can be attained.

The electrophotography polyurethane member of the present invention having the aforementioned characteristics is formed of a cast-formable polyurethane member and can be produced from polyol, polyisocyanate, and a diamino compound.

The diamino compound employed in the present invention has a melting point of 80° C. or lower. Differing from conventionally employed 2,2′,3,3′-tetrachloro-4,4′-diaminodiphenylmethane (TCDAM), the diamino compound employed in the present invention contains no chlorine atom in the molecular structure thereof, and, preferably, exhibits a reaction rate slower than that of 2,2′,3,3′-tetrachloro-4,4′-diaminodiphenylmethane under given hardening and molding conditions. When the reaction rate is not slower than that of 2,2′,3,3′-tetrachloro-4,4′-diaminodiphenylmethane, sheets fail to be formed due to such an excessively fast reaction rate.

The diamino compound assumes a liquid form or a solid form, and a liquid-form diamino compound is preferred. The diamino compound is, for example, a diaminodiphenylmethane compound or a phenylenediamine compound. Specific examples include 4,4′-methylenedianiline (DDM), 3,5-dimethylthio-2,4-toluenediamine, 2,4-toluenediamine (2,4-TDA), 2,6-toluenediamine (2,6-TDA), methylenebis(2-ethyl-6-methylamine), 1,4-di-sec-butylaminobenzene, 4,4-di-sec-butylaminediphenylmethane, 1,4-bis(2-aminophenyl)thiomethane, diethyltoluenediamine, trimethylenebis(4-aminobenzoate), and polytetramethylene oxide-p-aminobenzoate.

The aforementioned diamine compound is employed as a cross-linking agent for polyurethane and is preferably incorporated into the polyurethane composition in an amount of 0.15 mmol/g-composition or less.

Examples of the polyol include polyester-polyol (produced through dehydration condensation between diol and dibasic acid), polycarbonate-polyol (produced through reaction between diol and alkyl carbonate), caprolactone-type polyol, and polyether-polyol. The polyol content of the polyurethane is preferably 60 to 80 wt. %.

The polyisocyanate to be reacted with polyol preferably has a molecular structure which is relatively non-rigid. Examples of the polyisocyanate include 4,4′-diphenylmethane diisocyanate (MDI), 2,6-toluene diisocyanate (TDI), 1,6-hexane diisocyanate (HDI), 1,5-naphthalene diisocyanate (NDI), and 3,3-dimethylphenyl-4,4-diisocyanate (TODI). The polyisocyanate content is preferably 25 to 70 parts by mass with respect to 100 parts of polyurethane. When the polyisocyanate content is less than 25 parts by mass, tensile strength may be poor, whereas when the content is in excess of 70 parts by mass, permanent set increases excessively.

In the present invention, the diamino compound is employed as a cross-linking agent. In addition to the diamino compound, other diols and triols may be used in combination. No particular limitation is imposed on the type of diols, and propanediol (PD), butanediol (BD), etc. may be used. No particular limitation is imposed on the type of triols, and a triol having a molecular weight of 120 to 4,000 is preferred, with a triol having a molecular weight of 120 to 1,000 being more preferred. Specific examples include short-chain triols such as trimethylolethane (TME) and trimethylolpropane (TMP). The triol is added to the composition in order to improve characteristics such as creep and stress relaxation. No particular limitation is imposed on the proportion of the predominant cross-linking agent. Notably, diol and triol may be used in combination. Needless to say, two or more diols and two or more triols may be used in combination.

The α value is preferably 0.7 to 1.0. The term “α value” refers to a value calculated by the following equation:

α value=(amount (mol) of hydroxyl groups in cross-linking agent)/(amount (mol) of isocyanate groups remaining after reaction between polyol and isocyanate). When α value is more than 1.0, hydroxyl groups of the cross-linking agent remain and stain a photoreceptor of a similar member which the blade abuts, whereas when a value is less than 0.7, cross-linking density may lower excessively, resulting in poor mechanical strength, or may stain a photoreceptor due to a long period of time required for the deactivation of remaining isocyanate groups.

The aforementioned polyester-polyol and cross-linking agent are mixed with polyisocyanate, and the mixture is allowed to react, whereby polyurethane is produced. Any conventional production method such as the prepolymer method or the one-shot method may be employed. The prepolymer method is suitable in the present invention, since a polyurethane having excellent mechanical strength and wear resistance can be produced. However, no particular limitation is imposed on the production method.

By use of the above-produced polyurethane member, the electrophotography polyurethane member of the present invention exhibits remarkably decreased temperature dependency of rebound resilience and hardness while mechanical characteristics are maintained. Thus, the electrophotography polyurethane member of the invention is suitably employed as a cleaning blade or a similar member, which exhibits stable performance over a wide temperature range of low temperature to high temperature.

As described hereinabove, the present invention enables provision of an electrophotography polyurethane member which exhibits small temperature dependency of characteristics, excellent mechanical characteristics, and high wear resistance.

### EXAMPLES

The present invention will next be described in detail by way of examples, which should not be construed as limiting the invention thereto. Unless otherwise specified, the unit “part” is on a weight basis.

### Example 1

Polytetramethylene glycol (PTMG) (molecular weight: 1,000) (100 parts), 4,4′-diphenylmethane diisocyanate (MDI) (60 parts), and butanediol (BD)/trimethylolpropane (TMP)/3,5-dimethylthio-2,4-toluenediamine (DMTDA) serving as a cross-linking agent were mixed in such proportions that α value, the diamino compound ratio of the diol and the triol ratio of the cross-linking agent were adjusted to 0.95, 0.05 and 0.10, respectively. The resultant mixture was allowed to react, to thereby form a polyurethane. Test samples and test cleaning blades were produced from the polyurethane.

### Example 2

Polytetramethylene glycol (PTMG) (molecular weight: 1,400) (100 parts), 4,4′-diphenylmethane diisocyanate (MDI) (55 parts), and butanediol (BD)/trimethylolpropane (TMP)/3,5-dimethylthio-2,4-toluenediamine (DMTDA) serving as a cross-linking agent were mixed in such proportions that α value, the diamino compound ratio of the diol and the triol ratio of the cross-linking agent were adjusted to 0.95, 0.10 and 0.10, respectively. The resultant mixture was allowed to react, to thereby form a polyurethane. Test samples and test cleaning blades were produced from the polyurethane.

### Example 3

In a similar manner, caprolactone (PCL) (molecular weight: 2,000) (100 parts), 3,3-dimethylphenyl-4,4′-diisocyanate (TODI) (35 parts), and 3,5-dimethylthio-2,4-toluenediamine (DMTDA) serving as a cross-linking agent were mixed in such proportions that a value was adjusted to 0.95. The resultant mixture was allowed to react, to thereby form a polyurethane. Test samples and test cleaning blades were produced from the polyurethane.

### Comparative Example 1

Caprolactone (PCL) (molecular weight: 2,000) (100 parts), 4,41-diphenylmethane diisocyanate (MDI) (40 parts), and butanediol (BD)/trimethylolpropane (TMP) serving as a cross-linking agent were mixed in such proportions that a value and the triol ratio of the cross-linking agent were adjusted to 0.95 and 0.30, respectively, and the mixture was allowed to react, to thereby form a polyurethane. Test samples and test cleaning blades were produced from the polyurethane.

### Comparative Example 2

From 1,9-nonanediol and adipic acid, 1,9-ND adipate (molecular weight: 2,000) was produced. The 1,9-ND adipate (100 parts), 4,4′-diphenylmethane diisocyanate (MDI) (50 parts), and propanediol (PD)/trimethylolethane (TME) serving as a cross-linking agent were mixed in such proportions that α value and the triol ratio of the cross-linking agent were adjusted to 0.95 and 0.40, respectively, and the mixture was allowed to react, to thereby form a polyurethane. Test samples and test cleaning blades were produced from the polyurethane.

### Comparative Example 3

The procedure of Example 1 was repeated, except that polytetramethylene glycol (PTMG) (molecular weight: 2,000) was used instead of polytetramethylene glycol (PTMG) (molecular weight: 1,000); the amount of 4,4′-diphenylmethane diisocyanate (MDI) was changed to 40 parts; and Methylenebis(2,3-dichloroaniline) (TCDAM) (the product of IHARA CHEMICAL INDUSTRY CO., LTD.) was used instead of 3,5-dimethylthio-2,4-toulenediamine (DMTDA), to thereby form a polyurethane. Test samples and test cleaning blades were produced from the polyurethane.

### Comparative Example 4

Caprolactone (PCL) (molecular weight: 2,000) (100 parts), 4,4′-diphenylmethane diisocyanate (MDI) (40 parts), and butanediol (BD)/trimethylolpropane (TMP)/methylenebis(2-ethyl-6-methylaniline) (CUREHARD-MED) (the product of IHARA CHEMICAL INDUSTRY CO., LTD.) serving as a cross-linking agent were mixed in such proportions that α value, the diamino compound ratio of the diol and the triol ratio of the cross-linking agent were adjusted to 0.95, 0.10 and 0.10, respectively. The resultant mixture was allowed to react, to thereby form a polyurethane. Test samples and test cleaning blades were produced from the polyurethane.

### Test Example 1

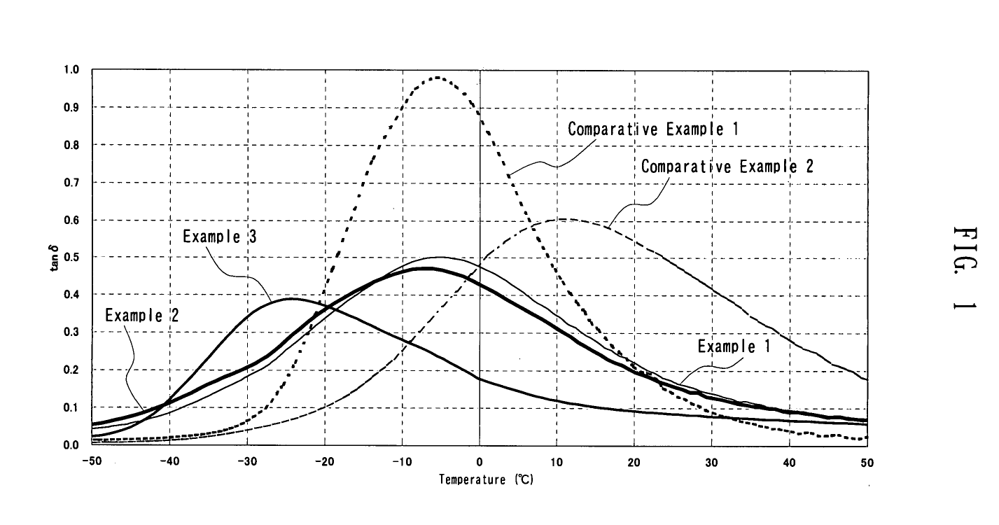

The physical properties of the test samples of Examples 1 to 3 and Comparative Examples 1 to 4 were determined as follows. Rubber hardness (Hs) at 25° C. was determined in accordance with JIS K6301. Tensile strength at 300% elongation (300% modulus) was determined in accordance with JIS K6251. Tensile strength and elongation at break were determined in accordance with JIS K6251. Tear strength was determined in accordance with JIS K6252. Young's modulus (25% elongation) was determined in accordance with JIS K6254. 100% Permanent set was determined in accordance with JIS K6262. Rebound resilience (Rb) at 25° C. was determined by means of a Lupke rebound resilience tester in accordance with JIS K6301. Peak temperature of tan δ (10 Hz) was determined by Seiko Instruments' thermal analysis apparatus EXSTAR 6000 DMS Viscoelasticity Spectrometer. The results are shown in FIG. 1 and Table 1. Rebound resilience (Rb) was determined also at 10° C. to 50° C., whereby temperature dependency thereof was evaluated. The results are also shown in Table 1.

### Test Example 2

Each of the cleaning blades of the Examples and the Comparative Examples was adapted in an actual apparatus (product of Fuji Xerox, DocuCentre Color 400) and pressed against a photoconductor, and the photoconductor was continuously rotated at a circumferential speed of 125 mm/sec for 60 minutes under LL conditions (10° C., 35%) or HH conditions (30° C., 85%), while no paper sheet was conveyed. After completion of the operation, the wear condition of an edge portion of the cleaning blade under HH conditions was observed under a laser microscope, and the amount of wear was microscopically determined. The wear was evaluated by average cross-section area of wear portions in accordance with the following ratings: O (0 to 10 μm²), Δ (11 to 20 μm²), and X (≧21 μm²). Generation of squeaky sounds was aurally checked and was evaluated in accordance with the following ratings: O (no squeaky sounds generated) and X (squeaky sounds generated). Under LL conditions, each cleaning blade was evaluated in terms of performance of cleaning a photoreceptor with the following ratings: O (excellent cleaning performance) and X (cleaning incomplete). The above tests were performed under the following conditions, and the results are shown in Table 1.

<Test Conditions>

Press conditions; Abutting angle: 25°, Pressure: 3 gf/cm

Photoconductor; OPC (coated with initial lubricant)

Charging conditions;

voltage in apparatus: Vd/−750 V, VI/−50 V
   Laser microscopy conditions;
Microscope: VIOLET LASER COLOR 3D PROFILE MICROSCOPE VX-9500 (product of KEYENCE Corporation), magnification: ×50
Mode: Ultra-depth color profiling
Optical zoom: ×1.0
Measurement pitch: 0.10 μm
Measurement points: 5 points per cleaning blade
   (i.e., points 20 mm from the respective ends, points 80 mm from the respective ends, and the center point)

### Test Example 3

A polyol, an isocyanate, and a cross-linking agent (made molten in advance at a temperature equal to or higher than the melting point of the employed diamino compound) were placed in predetermined amounts in a VAR-type rheometer (product of JASCO International, DAR2000 DynAlyser), and elevation in viscosity of the mixture was determined at a mold temperature of 150° C. Relative reaction rate of each diamino compound was determined, with viscosity increasing rate of the mixture employing 2,2′,3,3′-tetrachloro-4,4′-diaminodiphenylmethane being regarded as 1.

TABLE 1-1

| | | Ex. 1 | Ex. 2 | Ex. 3 |
|---|---|---|---|---|
| Polyol | | PTMG | PTMG | PCL |
| Molecular weight | | 1,000 | 1,400 | 2,000 |
| Isocyanate | | MDI | MDI | TODI |
| Isocyanate amount (parts) | | 60 | 55 | 35 |
| Diol | | BD/DMTDA | BD/DMTDA | DMTDA |
| Triol | | TMP | TMP | — |
| α Value | | 0.95 | 0.95 | 0.95 |
| Diamino compound ratio of the | | 0.05 | 0.10 | 1.00 |
| diol | | | | |
| Triol content in crosslinking | | 0.10 | 0.10 | — |
| agent | | | | |
| Diamino compound | | used | used | used |
| Melting point of diamino | | 4 | 4 | 4 |
| compound (° C.) | | | | |
| Relative reaction rate (vs. | | 0.5 | 0.5 | 0.5 |
| TCDAM) | | | | |
| Moldability | | ◯ | ◯ | ◯ |
| tanδ Peak intensity | | 0.50 | 0.47 | 0.39 |
| tanδ Peak temperature (° C.) | | −5 | −7 | −25 |
| tanδ Peak intensity/tanδ | | 7.09 | 6.64 | 6.54 |
| intensity at 50° C. | | | | |
| Item | Method | | | |
| Hardness (degree) | JIS K6301 | 75 | 74 | 84 |
| Rebound resilience | JIS K6301 | 36 | 41 | 49 |
| (%) | | | | |
| 300% M (MPa) | JIS K6251 | 13 | 20 | 14 |
| Tensile strength | JIS K6251 | 36 | 40 | 49 |
| (MPa) | | | | |
| Elongation at break | JIS K6251 | 400 | 380 | 509 |
| (%) | | | | |
| Tear strength | JIS K6252 | 73 | 68 | 98 |
| (kN/m) | | | | |
| Young's modulus | JIS K6254 | 7.4 | 8.2 | 13.5 |
| (MPa) | | | | |
| Permanent set (%) | JIS K6262 | 2 | 2 | 3 |
| Temperature- | 10 (° C.) | 21 | 25 | 38 |
| dependency of | 20 (° C.) | 29 | 37 | 47 |
| rebound | 25 (° C.) | 36 | 41 | 49 |
| resilience | 30 (° C.) | 43 | 45 | 49 |
| | 40 (° C.) | 52 | 54 | 50 |
| | 50 (° C.) | 60 | 55 | 53 |
| | Δ50 − 10 | 39 | 30 | 16 |

| | | | |
|---|---|---|---|
| Squeak sound in actual | ◯ | ◯ | ◯ |
| apparatus (HH) | | | |
| Wear resistance in actual | ◯ | ◯ | ◯ |
| apparatus (HH) | | | |
| Cleaning performance (LL) | ◯ | ◯ | ◯ |

TABLE 1-2

| | | Comp. | Comp. | Comp. | Comp. |
|---|---|---|---|---|---|
| | | Ex. 1 | Ex. 2 | Ex. 3 | Ex. 4 |
| Polyol | | PCL | 1,9-ND | PTMG | PCL |
| | | | agipate | | |
| Molecular weight | | 2,000 | 2,000 | 2,000 | 2,000 |
| Isocyanate | | MDI | MDI | MDI | MDI |
| Isocyanate amount (parts) | | 40 | 50 | 40 | 40 |
| Diol | | BD | PD | BD/TCDAM | BD/CUREHARDMED |
| Triol | | TMP | TME | TMP | TMP |
| α Value | | 0.95 | 0.95 | 0.95 | 0.95 |
| Diamino compound ratio of the diol | | — | — | 0.05 | 0.10 |
| Triol content in crosslinking agent | | 0.30 | 0.40 | 0.10 | 0.10 |
| Diamino compound | | — | — | used | used |
| Melting point of diamino compound | | — | — | 151 | 84 |
| Relative reaction rate (vs. TCDAM) | | — | — | 1 | 2 |
| Moldability | | ◯ | ◯ | X | X |
| tanδ Peak intensity | | 0.98 | 0.65 | 1)* | 1)* |
| tanδ Peak temperature (° C.) | | −6 | 12 | | |
| tanδ Peak intensity/tanδ intensity at | | 38.37 | 3.42 | | |
| 50° C. | | | | | |
| Item | Method | | | | |
| Hardness (degree) | JIS K6301 | 67 | 72 | | |
| Rebound resilience (%) | JIS K6301 | 51 | 23 | | |
| 300% M (MPa) | JIS K6251 | 11 | — | | |
| Tensile strength (MPa) | JIS K6251 | 26 | 32 | | |
| Elongation at break (%) | JIS K6251 | 350 | 240 | | |
| Tear strength (kN/m) | JIS K6252 | 39 | 54 | | |
| Young's modulus (MPa) | JIS K6254 | 6 | 7 | | |
| Permanent set (%) | JIS K6262 | 1 | 1 | | |
| Temperature-dependency | 10 (° C.) | 23 | 16 | | |
| of rebound resilience | 20 (° C.) | 40 | 19 | | |
| | 25 (° C.) | 51 | 23 | | |
| | 30 (° C.) | 58 | 29 | | |
| | 40 (° C.) | 71 | 42 | | |
| | 50 (° C.) | 77 | 55 | | |
| | Δ50 − 10 | 54 | 39 | | |

| | | |
|---|---|---|
| Squeak sound in actual apparatus | X | ◯ |
| (HH) | | |
| Wear resistance in actual apparatus | Δ | ◯ |
| (HH) | | |
| Cleaning performance (LL) | ◯ | X |

1)* Not measurable, sheet formation failed due to excessively fast rate of reaction.

The cleaning blades of Examples 1 to 3 exhibited a tan δ peak intensity of 0.7 or lower and a (tan δ peak intensity/tans intensity at 50° C.) of 10 or less, indicating excellent mechanical characteristics. The cleaning blades of Examples 1 to 3 also exhibited small temperature dependency of rebound resilience while mechanical characteristics were maintained. Thus, these cleaning blades were found to attain consistent cleaning performance at both low temperature and high temperature. In addition, these cleaning blades generated no squeaky sounds when employed in an actually employed apparatus, and exhibited excellent wear resistance and cleaning performance under LL conditions. Therefore, the cleaning blade of the present invention is suitable for use in an actually employed apparatus.

In contrast, the cleaning blades of Comparative Examples 1 and 2, which had been produced without a diamino compound, exhibited a tan δ peak intensity higher than 0.7 (Comparative Example 1) or a peak temperature higher than 5° C. (Comparative Example 2). These cleaning blades exhibited relatively large temperature dependency of rebound resilience. The cleaning blade of Comparative Example 1 generated squeaky sounds, and that of Comparative Example 2 exhibited poor cleaning performance under LL conditions. Thus, these cleaning blades were found to be unsuited for an actually employed apparatus. Comparative Examples 3 and 4 employed a diamino compound having a melting point of 80° C. or higher and a chlorine atom in the molecular structure thereof and exhibiting a reaction rate faster than that of 2,2′,3,3′-tetrachloro-4,4′-diaminodiphenylmethane. In Comparative Examples 3 and 4, formation of polyurethane sheet could not be attained.

What is claimed is:

1. A cast-formable electrophotography polyurethane member produced through hardening and molding a polyurethane composition containing at least polyol, polyisocyanate, and a diamino compound, wherein the diamino compound has a melting point of 80° C. or lower and contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

2. An electrophotography polyurethane member according to claim 1, wherein the polyurethane member exhibits a tans peak intensity of 0.7 or lower and a (tans peak intensity/tan δ intensity at 50° C.) of 10 or less.

3. An electrophotography polyurethane member according to claim 1, wherein the diamino compound is incorporated into the polyurethane composition in an amount of 0.15 mmol/g or less.

4. An electrophotography polyurethane member according to claim 1, wherein the polyurethane member exhibits a tan δ (10 Hz) peak temperature of 5° C. or lower.

5. An electrophotography polyurethane member according to claim 1, wherein the polyurethane member exhibits a ((rebound resilience at 50° C.)−(rebound resilience at 10° C.)) of 40% or less.

6. An electrophotography polyurethane member according to claim 1, wherein the polyurethane member exhibits a hardness (JIS A) of 70 to 95°.

7. An electrophotography polyurethane member according to claim 1, wherein the polyurethane member is employed as a blade member.
